(19) United States
(12) Patent Application Publication
(10) Pub. No.: US 2026/0235466 A1
(43) Pub. Date: Aug. 13, 2026

(54) DEVICE TO IMPROVE THE ACCURACY AND RELIABILITY OF LIQUID LEVEL MEASUREMENTS AND PRESSURE MEASUREMENTS USING DIFFERENTIAL PRESSURE SENSING ELEMENTS

(71) Applicant: Flow-Tronic S.A., Welkenraedt (BE)

(72) Inventor: Jean-Marie SEVAR, Welkenraedt (BE)

(21) Appl. No.: 19/155,177

(22) PCT Filed: Feb. 9, 2024
(86) PCT No.: PCT/EP2024/053322

§ 371 Date: Aug. 8, 2025

(30) Foreign Application Priority Data
Feb. 16, 2023 (EP) 23157075.5

(51) Int. Cl. G01L 19/14; G01F 23/14

(52) U.S. Cl. CPC G01L 19/147; G01F 23/14

(57) ABSTRACT

The present disclosure relates to a device for measuring a liquid level and/or a pressure difference between two atmospheres. The device has a sensor body with an inner volume partly delimited by a wall. The sensor body includes, inside the inner volume:
an atmospheric pressure chamber,
a differential pressure sensing element disposed inside the atmospheric pressure chamber, and
a capillary tube connecting the atmospheric pressure chamber to the outside of the device under atmospheric pressure.

The atmospheric pressure chamber has a fixed part and a removable part with the differential pressure sensing element disposed inside the removable part so that the differential pressure sensing element can be easily replaced.

### FIELD

The present disclosure relates to a device using a differential pressure sensing element to measure a pressure, a liquid level and a liquid flowrate if associated to a liquid velocity measuring device.

### BACKGROUND

Area/velocity flowmeters for open channel or fluid flowing in an underground pipe or channel allow to calculate the flow rate by computing the shape and liquid level in order to calculate the wet area and using the continuity equation Q=V*A where A is the wet area and V is the liquid velocity. Area/velocity flowmeters using a level measuring device associated to a velocity measuring device as well as differential pressure sensing devices to measure pressure and liquid level are used for decades. The various velocity measuring devices such as electromagnetic or ultrasonic sensors associated to a multitude of integrated level measuring devices such as up-looking ultrasonic sensors, differential pressure or separated down-looking devices such as ultrasonic, microwave, or laser level sensors measuring the distance from the sensor to the liquid level are used with various level of success. The integrated level sensing devices ease the installation process as only one sensor needs to be installed but if the level sensor becomes defective, the whole area/velocity sensor needs to be replaced. The separate level sensor does not suffer from that inconvenience but it is much more difficult to install and more expensive as two sensor housings and two cables are needed. The integrated differential pressure sensing element is the most used option because of its accuracy, but the sensing elements are very fragile as they must be able to measure a couple of millimeters up to several meters of liquid level. Another tendency is to pack all electronics into the sensing element, avoiding separate flow calculation devices, but it becomes very expensive in case the differential pressure sensing element becomes defective and everything needs to be replaced. With the differential pressure sensing element used in liquid level measuring devices, less electronics are involved, but the tendency is to increase the amount of electronics because of various outputs such as 4-20 mA, serial digital MODBUS and SDI-12, and digital linearization, digital temperature compensation and more are present. The result is the same, more electronics packed into the differential pressure sensing element or liquid level measuring device that increase the costs when only the differential pressure sensing element would need to be replaced.

In addition, the differential pressure sensing elements used for liquid level measurement request a capillary tube to connect the negative pressure side from the differential pressure sensing element to the atmospheric pressure. At the end of the capillary tube, special precaution is requested so that moisture cannot enter the capillary tube. This is done by adding a filter element being permeable to air and impermeable to moisture. Those filter elements are not always 100% efficient and special desiccant chambers are added, which need regular maintenance replacing the desiccative material.

Another solution to avoid a capillary tube is the use of two absolute pressure sensors, one measuring the liquid level with the atmospheric pressure, the second measuring only the atmospheric pressure. This of course adds costs as two separate pressure sensing devices are required with their associated electronics. An additional secondary electronic device needs to calculate the difference between the two pressures to have the net pressure applied by the liquid level.

Another problem from the capillary tube is when humidity has been passing the filter barrier and is condensing inside the capillary tube building a water column, the liquid level reading becomes jumpy, instable, or totally unusable. The cable needs to be cut and a hermetical cable junction including the capillary tube junction needs to be made, which is very often impossible to make.

### SUMMARY

The present disclosure aims to provide an improved device to measure the liquid level using a differential pressure sensing element that will not suffer from the problems of the present liquid level measuring devices using an integrated differential pressure sensing element. Such a device may also be used to measure a pressure difference between two atmospheres.

More specifically, the present disclosure relates to a device for measuring a liquid level and/or a pressure difference between two atmospheres, said device comprising a sensor body with an inner volume, said sensor body comprising in the inner volume:
an atmospheric pressure chamber,
a differential pressure sensing element disposed inside the atmospheric pressure chamber,
a capillary tube connecting said atmospheric pressure chamber to the outside of the device under atmospheric pressure,
   said atmospheric pressure chamber comprising a fixed part and a removable part with the differential pressure sensing element disposed inside the removable part so that the differential pressure sensing element can be easily replaced.

For an area/velocity flowmeter, the sensor body comprises one or more additional sensing elements to measure the velocity of the liquid, said one or more additional sensing elements being positioned inside the inner volume but outside the atmospheric pressure chamber.

The differential pressure sensing element is by far the most sensitive and most fragile part of the whole system. The membrane from the positive side made from stainless steel, Hastelloy, ceramic material or any other material can be exposed to very aggressive liquids such as industrial and domestic wastewater and chemicals which can deteriorate the membrane, the seal or even the body of the differential pressure sensing element over time. The negative side of the differential pressure sensing element is exposed to the atmospheric air and its humidity, atmospheric air which in sewers or chemical industry can be loaded with aggressive gases. This all leads to the fact that the differential pressure sensing element is the most sensitive part and goes defective the most often. Allowing the replacement of the differential pressure sensing element or maintaining it by replacing its seal drastically reduces the costs.

In addition, according to a preferred embodiment, the sensor body comprises inside the atmospheric pressure chamber, a pressure and humidity sensors monitoring the conditions inside the atmospheric pressure chamber allowing for alarming when maintenance is needed. Indeed, the end of the capillary tube exposed to the atmosphere needs to be protected by a special filter being permeable to air and impermeable to humidity, or by a desiccative chamber containing desiccant that needs to be replaced over time, or both. The desiccant usually changes color when replacement is needed, but this requests a technician to go on site and check the color of the desiccant which is time consuming with the hope it is not too late. By monitoring the humidity inside the atmospheric pressure chamber, an alarm can be triggered when it is time to change the desiccant or replace the membrane filter.

In addition, according to a preferred embodiment, the atmospheric pressure chamber is designed to allow the cleaning from the capillary tube from dirt, humidity, or water by applying an overpressure inside the atmospheric pressure chamber using dried compressed air or inert dry gas from a pressurized gas container. To this end, the present disclosure also relates to a kit comprising the device with the sensor body as described above and a removable cleaning assembly intended to replace the removable part in order to clean the capillary tube from humidity, moisture, water and/or dirt intrusion, said removable cleaning assembly comprising means for applying an overpressure inside the atmospheric pressure chamber.

### BRIEF DESCRIPTION OF THE DRAWINGS

FIG. 1 represents the measuring device according to the present disclosure including the fixed part of the atmospheric pressure chamber and the removable part of the atmospheric pressure chamber. In this variant, the measuring device is an area/velocity flowmeter.

FIG. 2 represents an enlarged view of FIG. 1 with a focus on the atmospheric pressure chamber.

FIG. 3 represents another variant of the measuring device according to the present disclosure. In this variant, the measuring device is a liquid level measuring device.

FIG. 4 represents an enlarged view of FIG. 3 with a focus on the atmospheric pressure chamber.

FIG. 5 represents a view of the FIG. 2 wherein the removable part has been replaced by a cleaning element for the capillary tube.

FIG. 6 represents a view of the FIG. 4 wherein the removable part has been replaced by a cleaning element for the capillary tube.

### DETAILED DESCRIPTION

The present disclosure relates to a device using a differential pressure sensing element, said device may be a liquid level measuring device or a device to measure the pressure difference between two atmospheres. The device may be a combined sensor device using a differential sensing element associated to one or more additional sensing elements such as a velocity measurement system to make an area/velocity flowmeter or to any type of device using a differential pressure sensing element preferably associated to one or more other sensing elements. For measuring the liquid level or flow rate, said device is immerged in the fluid during the measurements. The liquid level is calculated based on the difference of pressure between the pressure inside the atmospheric pressure chamber (negative side) and the pressure exerted by the liquid on the differential pressure sensing element (positive side).

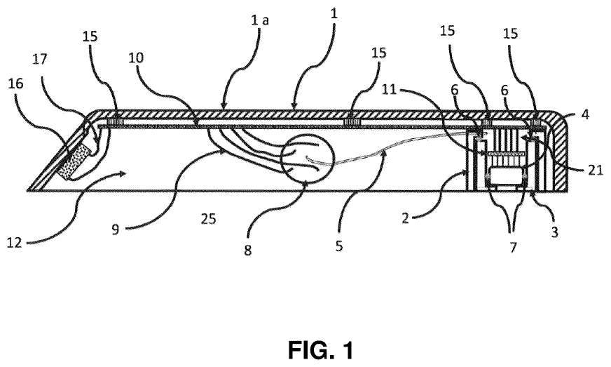

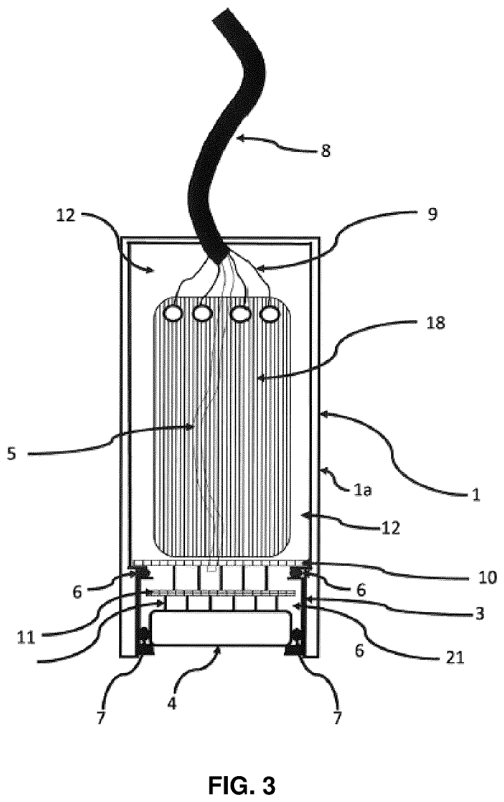

The sensor body 1 is described in FIGS. 1, 2 and 5 for an area/velocity measuring device. It is described in FIGS. 3, 4 and 6 for a liquid level measuring device.

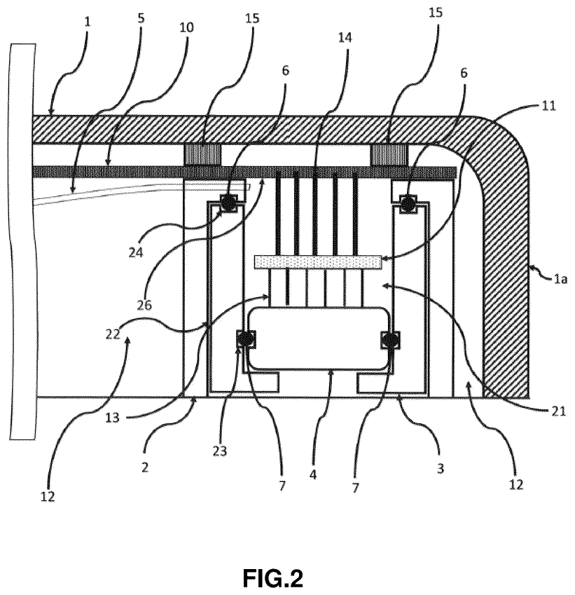

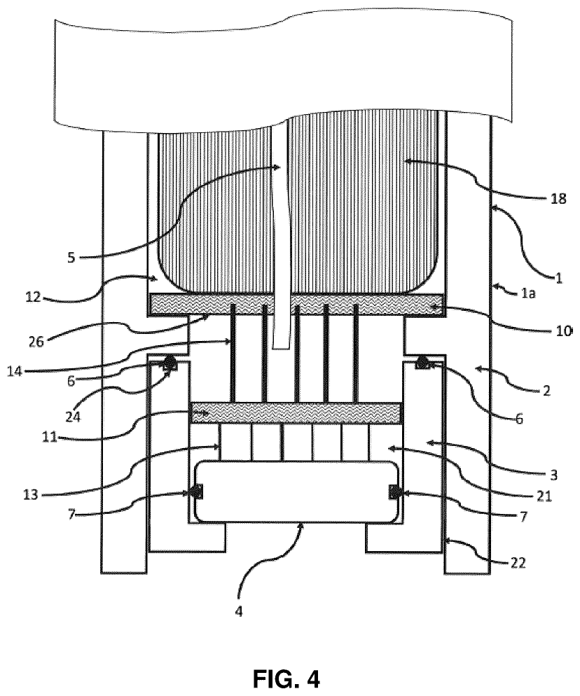

The sensor body 1 has an inner volume partly delimited by a wall 1a, the perimeter of the rest of the inner volume being intended to be in direct contact with the fluid 25 (schematically represented). The inner volume comprises the atmospheric pressure chamber 21 and outside the atmospheric pressure chamber a sealing material 12. The atmospheric pressure chamber 21 comprises a fixed part 2 and a removable part 3 that contains the differential pressure sensing element 4, said removable part being able to be easily removed from the sensor body. The fixed part 2 may be part of the wall 1a of the sensor body as shown in FIG. 4 or attached to the wall 1a directly or via another element like a Printed Circuit Board (PCB) 10 in the example of FIG. 2.

The sensor body 1 comprises a capillary tube 5 which must allow the atmospheric pressure conveyed by said capillary tube to reach the inside of the atmospheric pressure chamber 21. Said capillary tube 5 extends from the inside of the atmospheric pressure chamber 21 to the outside of the sensor body, out of the fluid to access the ambient atmosphere. This can be done by allowing the capillary tube 5 to pass hermetically sealed through the fixed part 2 of the atmospheric pressure chamber 21 as shown in FIG. 2 or through the wall 1a of the inner body 1 and the PCB 10 as shown in FIG. 3.

The sensor body 1 comprises a main Printed Circuit Board (PCB) 10 outside the atmospheric pressure chamber 21. The PCB 10 may be fixed to the wall and/or fixed part directly or via another element like the supports 15 on an inner face of the wall 1a (FIG. 1). In the variant of FIGS. 1 and 2, the fixed part 2 from the atmospheric pressure chamber 21 is hermetically attached to the PCB 10, special glue can be used to attach and seal the fixed part 2 of the atmospheric pressure chamber to the main PCB 10, but any other suitable technique can be used as well. For this variant, the sensor body 1 may be machined, injected or 3D printed and preferably, to safe space, the fixed part 2 of the atmospheric pressure chamber is a separate machined, injected or 3D printed assembly that is hermetically fixed on the main PCB 10.

The sensor body 1 also comprises on one or more cables 8 with its electrical conductors 9 positioned outside the atmospheric pressure chamber 21, said electrical conductors allowing the electrical connection from the main PCB 10 to the outside world (the extension of the cables to the outside world being not represented in FIG. 1). The cable 8 may also contain the capillary tube 5 extending to the outside world as well.

The differential pressure sensing element 4 usually has several electrical connections or pins 13 allowing to supply the sensing element and allowing to gather the information data from the sensing element (FIG. 2 and FIG. 4). The data can be an analog electrical signal (μV, mV, μA, mA) or a digital electrical signal. The pins 13 of the differential pressure sensing element are usually connected by using a small PCB 11 disposed inside the removable part. The electrical signals are transferred from the removable part 3 and more specifically from the PCB 11 to the main PCB 10, preferably by spring loaded contact pins 14 allowing a distance flexibility between the removable part and the fixed part. All linearization, temperature compensation and output signal adjustment can be made within the differential pressure sensing element or can be done by the outside electronic PCB 10 or by any detached electronics. It is recommended to minimize the signal conversions made within the differential pressure sensing element 4 to reduce its costs. According to the present disclosure, the PCB 11 and the electrical conductors 13 are removable with the removable part 3 comprising the differential pressure sensing element 4.

FIGS. 2 and 4 show the removable part 3 of the atmospheric pressure chamber 21 that contains the differential pressure sensing element 4. This sensing element is usually circular and contain one or more seals 7 to avoid the liquid to be measured to penetrate to the negative side of the differential pressure sensing element, i.e. the part under the atmospheric pressure conveyed by the capillary tube. Usually O-Ring type of seals are used, but any type of suitable seal could be used as well. Typically, the seal 7 is housed in a recess 23 provided in the removable part 3 and in the differential pressure sensing element 4. In addition, the removable part 3 of the atmospheric pressure chamber needs to be hermetically fixed into the fixed part 2 of the atmospheric pressure chamber. This can be achieved in different ways, but the easiest way is the use of a fine pitch thread 22 allowing the removable part 3 of the atmospheric pressure chamber to be hermetically screwed into the fixed part 2 of the atmospheric pressure chamber. The hermitical seal can be done by using thread sealing products or by using a seal 6 or by using both. Typically, the circular seal 6 is housed in a recess 24 provided in the fixed part 2 and in the removable part 3.

For the area/velocity measuring device of FIG. 1, the sensor body 1 has one or more additional sensing elements 16 to measure the velocity, usually crystals to generate an ultrasonic wave to measure the speed of the surrounding liquid by the Doppler effect or any other liquid velocity sensing element like an electromagnetic sensing element, which in combination with the differential pressure sensing element makes it an area/velocity flowmeter. The additional sensing elements 16 may for example be positioned on an inner face of the wall 1a of the sensor body 1, outside the atmospheric pressure chamber 21. They are connected to the main PCB 10 via an electrical conductor 17.

In addition, the sensor body for all variants may comprise microchip sensors capable to monitor temperature, pressure, humidity, and gas concentrations within the atmospheric pressure chamber 21. Those microchip sensors 26 can be mounted on the interconnecting PCB 11 disposed inside the atmospheric pressure chamber 21 or preferably on the main PCB 10 at a location where they are facing the inside of the atmospheric pressure chamber.

The inner volume of the sensor body 1 outside the atmospheric pressure chamber 21 may be at least partly filled with a sealing material 12 like a 2 component Epoxy or PU (polyurethane) resin that seals the inside from the liquid to be measured. The cable 8, the electrical conductors 9, the capillary tube 5 and the one or more additional sensing elements 16 are partially embedded in the sealing material 12.

FIGS. 3 and 4 show the variant for the liquid level measuring device. In this case the fixed part 2 of the atmospheric pressure chamber is machined, injected or 3D printed into the sensor body 1. A separate fixed part of the atmospheric pressure chamber could be used as well but is generally not needed. Preferably, an additional PCB 18 is used as all electronic circuitries would not find enough space on the main PCB 10 with a smaller size than in the variant of FIG. 1. Preferably, the PCB 18 and PCB 10 are positioned outside the atmospheric pressure chamber 21. The PCB 10 is hermetically attached on the fixed part from the atmospheric pressure chamber using special glue or any other suitable technology. The capillary tube 5 conveying the atmospheric pressure inside the atmospheric pressure chamber 21 passes the PCB 10 hermetically or is hermetically fixed on a small tube soldered on the PCB 10 and making the connection between the capillary tube 5 and the inside of the atmospheric pressure chamber.

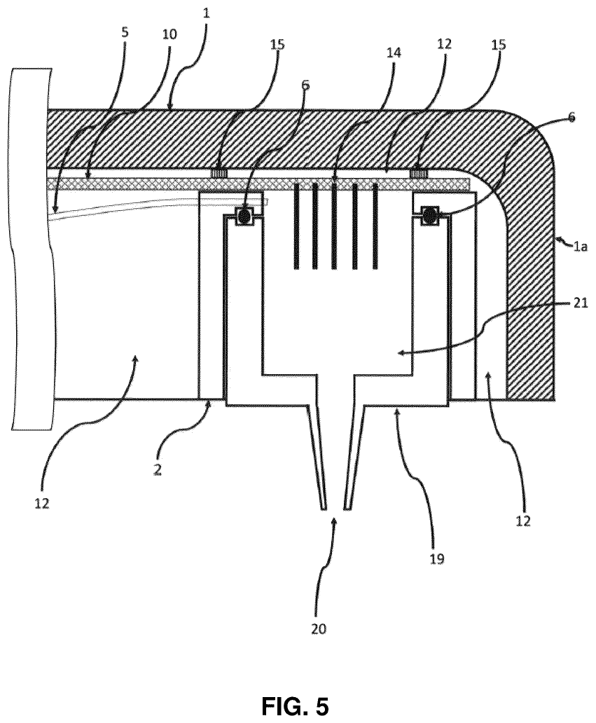

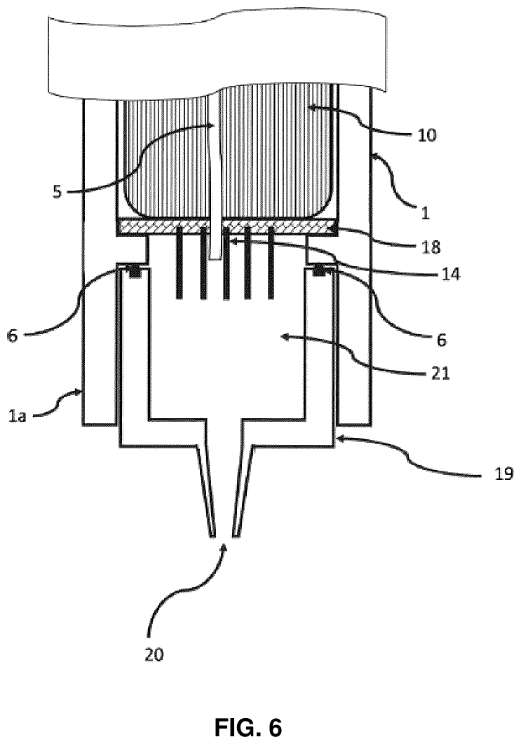

FIGS. 5 and 6 show the atmospheric pressure chamber 21 with its removable part replaced by a special removable assembly body 19, also called removable cleaning element. Said assembly body allows to pressurize the atmospheric pressure chamber 21 and the capillary tube 5 to clean and dry the capillary tube 5 by using dried pressurized air or inert gas from a pressurized container. The pressurized air or gas is applied using the orifice 20. Any accumulated humidity, dirt or water in the capillary tube 5 is flushed out by the pressurized air or gas. The removable assembly body 19 is also hermetically sealed with the fixed part using the seals 6.

1. A device for measuring a liquid level and/or a pressure difference between two atmospheres, the device comprising a sensor body having an inner volume partly delimited by a wall, the sensor body comprising inside the inner volume:
an atmospheric pressure chamber;
a differential pressure sensing element disposed inside the atmospheric pressure chamber;
a capillary tube connecting the atmospheric pressure chamber to an outside of the device under atmospheric pressure; wherein the atmospheric pressure chamber comprises a fixed part and a removable part the differential pressure sensing element disposed inside the removable part.

2. The device according to claim 1, wherein the inner volume outside the atmospheric pressure chamber is at least partly filled with a sealing material.

3. The device according to claim 1, wherein the sensor body comprises in the inner volume a main Printed Circuit Board (PCB) disposed outside the atmospheric pressure chamber.

4. Device The device according to claim 3, wherein the sensor body comprises in the inner volume one or more cables housing first electrical conductors, the one or more cables being positioned disposed outside the atmospheric pressure chamber with the electrical conductors allowing electrical connection from the main PCB to the outside of the device.

5. The device according to claim 3, wherein the main PCB is fixed on a support on an inner face of the wall.

6. The device according to claim 3, wherein the sensor body comprises a second PCB and second and third electrical conductors disposed inside the atmospheric pressure chamber, the second electrical conductors connecting the differential pressure sensing element to the second PCB and the third electrical conductors connecting the second PCB to the main PCB or to a third PCB connected to the main PCB to transfer electrical signals from the removable part to the outside of the device.

7. The device according to any one of previous claim 1, wherein the sensor body comprises a first seal between the removable part and the differential pressure sensing element, the first seal configured to prevent liquid entering the atmospheric pressure chamber in a section wherein the atmospheric pressure is conveyed by the capillary tube.

8. The device according to claim 1, wherein the sensor body comprises a second seal between the fixed part and the removable part, such that the removable part is hermetically attached to the fixed part.

9. The device according to any one of previous claim 1, wherein the sensor body comprises one or more additional sensing elements configured to measure a velocity of the liquid, the one or more additional sensing elements being disposed inside the inner volume outside the atmospheric pressure chamber.

10. The device according to claims, characterized in that claim 1, wherein the fixed part is part of the wall of the sensor body.

11. The device according to claim 1, wherein the sensor body comprises sensors to monitor temperature, pressure, humidity, and/or gas concentrations within the atmospheric pressure chamber.

12. The device according to claim 6, wherein the removable part comprises the differential pressure sensing element, the second PCB, and the second electrical conductors.

13. A kit comprising the device according to claim 1 and a removable cleaning assembly configured to replace the removable part to clean the capillary tube from humidity, moisture, water, and/or dirt intrusion, the removable cleaning assembly comprising means for applying an overpressure inside the atmospheric pressure chamber.

14. The device according to claim 3, wherein the main PCB is fixed on a support embedded in a sealing material of the inner volume.

15. The device according to claim 1, wherein the sensor body comprises a pitch thread between the fixed part and the removable part.

16. The device according to claim 1, wherein the fixed part is attached to the wall directly or via another element.
